(19) United States
(12) Patent Application Publication
(10) Pub. No.: US 2010/0136330 A1
(43) Pub. Date: Jun. 3, 2010

(54) PRECOATED METAL SHEET

(75) Inventors: Kohei Ueda, Tokyo (JP); Kengo Yoshida, Tokyo (JP); Hiroshi Kanai, Tokyo (JP); Shiro Kamiyama, Saitama (JP); Shizuo Kimura, Saitama (JP)

Correspondence Address: ARENT FOX LLP, 1050 CONNECTICUT AVENUE, N.W., SUITE 400, WASHINGTON, DC, 20036, US

(73) Assignee: Honda Motors Co., Ltd., Minato-ku, tokyo (JP)

(21) Appl. No.: 12/596,565

(22) PCT Filed: Apr. 21, 2008
(86) PCT No.: PCT/JP2008/057684

§ 371 Date: Oct. 19, 2009

(30) Foreign Application Priority Data
Apr. 23, 2007 (JP) 2007-113535

(51) Int. Cl. B32B 15/09; B32B 15/04

(52) U.S. Cl. 428/336; 428/457; 428/472; 428/458

(57) ABSTRACT

[PROBLEMS] To provide a precoated metal sheet allowing to skip postcoating after press working that realizes high whiteness degree and excels in bright reflectivity. [MEANS FOR SOLVING PROBLEMS] A white precoated metal sheet of 80 or higher postcoating whiteness degree in terms of L-value of Hunter Lab color system, comprising a metal sheet provided with two or more coating layers, wherein when the superior layer coating refers to the coating constituting the outermost surface layer and the inferior layer coating refers to the coating interposed between the superior layer coating and the metal sheet, the content of white pigment in the inferior layer coating is in the range of 40 to 60 mass % while the content of white pigment in the superior layer coating is in the range of 5 to 25 mass % so as to excel in bright reflectivity.

### TECHNICAL FIELD

The present invention relates to a precoated metal sheet, and specifically relates to a precoated metal sheet having a high image clarity in uses for automobiles, home electronics, architectural materials, civil engineering, machinery, house furnishings, containers and the like.

### BACKGROUND ART

Precoated metal sheets coated with a coating that is colored in advance have been increasingly used instead of post-coating products obtained by coating conventional metal sheets after processing, for outer sheets in the fields of automobiles, home electric appliances, architectural materials and the like. Meanwhile, in these applications, demand for coating appearance having high image clarity has been increased in view of designing and device property.

As techniques for improving image clarity of coatings, for example, a technique including decreasing the surface roughness of a metal sheet (base material) as described in Patent Document 1; a technique including applying a coating using a resin having a low molecular weight as described in Patent Document 2; a technique including applying a clear coating on a colored coating layer as described in Patent Document 3, and the like are disclosed.

In the case where precoated metal sheets are industrially produced, they are produced in a continuous coating line referred to as a coil coating line, as described in Non-Patent Document 1. In a general coil coating line, a two-coating specification in which a primer coating having an anticorrosive property is applied to a metal sheet by a coating apparatus referred to as a roll coater or a curtain coater and a colored coating is applied thereon, is generally used.
Patent Document 1: JP-A No. 7-150326
Patent Document 2: JP-A No. 1-304934
Patent Document 3: JP-A No. 10-66931
Non-Patent Document 1: Ueda et al.; Color Materials, 72 (8), 525-531 (1999)

### DISCLOSURE OF THE INVENTION

### Problems to be Solved by the Invention

In the method for obtaining an image clarity by regulating the surface roughness of a base material of a precoated metal sheet to be low, a relatively high image clarity can be obtained by using any coating as long as the surface roughness of the metal sheet (base material) can be controlled, whereas the surface roughness of the metal sheet (base material) must be controlled by rolling a metal by a rolling mill roll having an adjusted surface roughness or the like, polishing by a polishing machine, or the like. Therefore, preparation of a precoated metal sheet having a high image clarity by this method has a drawback of much labor and costs. Meanwhile, a method for obtaining a precoated metal sheet having a high image clarity by applying a coating using a resin having a low molecular weight can produce relatively easier than the method including obtaining by controlling the surface roughness of the metal sheet (base material), but it is difficult to impart other coating properties such as processing property since a specific resin must be used for the coating.

As a method for obtaining relatively easily a precoated metal sheet having a high image clarity, a method including applying a transparent clear coating on a colored coating layer is preferable. However, where a transparent clear coating is applied on a colored coating layer in a conventional coil coating line for two-coat application, it is necessary to apply the colored coating layer directly on the metal sheet and apply the clear coating layer thereon. Therefore, where the colored coating layer is a white coating having a low hiding power, the color of the metal sheet (base sheet) cannot hide by only one colored layer, and thus it was difficult to exhibit a bright color tone.

Accordingly, the present invention has been made in view of such problems, and the object thereof is to solve these conventional problems to improve the substrate hiding power of a colored coating layer and provide a precoated metal sheet having a high image clarity and a production method thereof.

### Means for Solving the Problems

The present inventors have done intensive studies so as to solve the above-mentioned problems and found that a precoated metal sheet having an increased whiteness degree and a high image clarity by slightly adding a small amount of a white pigment to a transparent clear coating layer to be applied on a white colored layer to give a translucent coating.

The present invention has been completed based on the above-mentioned finding, and the summary of the present invention is as follows.
(1) A white precoated metal sheet having a post-coating whiteness degree of 80 or more in terms of L-value of Hunter Lab color system, comprising a metal sheet and two or more coating layers applied thereon, characterized in that, when an upper layer coating refers to the coating of an outermost surface layer and an under layer coating refers to the coating layer adjacent to the bottom of the upper layer coating, the concentration of a white pigment in the under layer coating is 40 to 60 mass % and the concentration of a white pigment in the upper layer coating is 5 to 25 mass %.
(2) The precoated metal sheet according to (1), characterized in that the white pigment is titanium oxide.
(3) The precoated metal sheet according to (1) or (2), characterized in that a resin that forms the under layer coating and the upper layer coating is a resin comprising a polyester resin as a main resin which has been crosslinked by a melamine resin or an isocyanate.
(4) The precoated metal sheet according to any one of (1) to (3), characterized in that the glass transition temperature of the under layer coating and the upper layer coating is 10 to 30° C.
(5) The precoated metal sheet according to any one of (1) to (3), characterized in that the coating thickness of the under layer coating is 10 to 25 μm, and the coating thickness of the upper layer coating is 5 to 25 μm.
(6) The precoated metal sheet according to any one of (1) to (5), characterized in that the coating of the precoated metal sheet includes two layers.
(7) The precoated metal sheet according to any one of (1) to (5), characterized in that a clear coating has been further applied on the upper layer coating of the precoated metal sheet.

### Effect of the Invention

According to the present invention, there can be provided a precoated metal sheet having a higher whiteness degree than before and being excellent in image clarity. Specifically, easy production of a precoated metal sheet having a high whiteness degree and being excellent in image clarity became possible even in a coil coating line for conventional two-coat application. Therefore, a precoated metal sheet can be easily applied to a white site that requires image clarity, which could be handled only by post-coating in the past; the problem of volatile organic solvents (VOC), which was a problem in post-coat application, can be solved by using the precoated metal sheet; and decreasing in cost, spacing of factories, and the like can be achieved by elimination of coating facilities by users. Therefore, the present invention can be considered to be an invention of extremely great value in industry.

### BEST MODE FOR CARRYING OUT THE INVENTION

Hereinafter, the preferred embodiments of the present invention are described in detail.

An object of the present invention can be achieved by a white precoated metal sheet having a post-coating whiteness degree of 80 or more in terms of L-value of Hunter Lab color system, including a metal sheet and two or more coating layers applied thereon, wherein when an upper layer coating refers to the coating of an outermost surface layer and an under layer coating refers to the coating between the upper layer coating and the metal sheet, the concentration of a white pigment in the under layer coating is 40 to 60 mass % and the concentration of a white pigment in the upper layer coating is 5 to 25 mass %.

The coating in the present invention is a white coating. As used herein, white refers to a coating that is colored by a pigment composition including a white pigment as a main component, and includes all color tones obtained by solely a white pigment, or by adding a small amount of other coloring pigment to a white pigment. Examples of color names include those referred to as white, flesh color, ivory, light pink, bluish white, light gray and the like, generally a color tone referred to as a pale color having an L-value of 80 or more in terms of Hunter Lab color system.

The precoated metal sheet of the present invention essentially has a white pigment concentration of 40 to 60 mass % in the under layer coating, and a white pigment concentration of 5 to 25 mass % in the upper layer coating. It is inappropriate that the pigment concentration in the under layer coating is lower than 40 mass % since the whiteness degree of the coating is decreased, or that the pigment concentration exceeds 60 mass % since the coating becomes brittle and the workability is decreased. It is inappropriate that the pigment concentration in the upper layer coating is lower than 5 mass % since the whiteness degree is decreased, or that the pigment concentration exceeds 25 mass % since the image clarity is decreased.

Examples of the white pigment to be used in the present invention may include generally known white pigments such as titanium oxide and zinc oxide, and titanium oxide is more preferable since it has high hiding power. As the titanium oxide to be used for the white pigment of the present invention may be a generally known titanium oxide. For example, as a commercially available titanium oxide, “TIPAQUE” manufactured by Ishihara Sangyo Kaisha Ltd., “TITANIX” manufactured by Tayca Corporation, and the like can be used.

Besides the white pigment, colored pigments other than white can be added to the coating of the present invention. As the colored pigments other than the white pigment, generally known pigments, for example, red pigments such as inorganic red pigments such as cadmium red and vermilion, organic soluble azo red pigments such as Carmine 6B, Lake Red C and watching Red, organic insoluble azo red pigments such as permanent red, Lake red 4R and naphthol red, and condensed azo red pigments such as chromophthal red; yellow pigments such as inorganic yellow pigments such as yellow lead, yellow iron oxide and cadmium yellow, and organic yellow pigments such as disazo yellow, monoazo yellow and condensed azo yellow; orange pigments such as inorganic orange pigments such as molybdenum orange, and organic orange pigments such as disazo orange and permanent orange; blue pigments such as phthalocyanine blue and phthalocyanine green; and black such as carbon black, can be used.

In the coating of the present invention, an anticorrosive pigment may be added besides the white pigment and the colored pigments. As the anticorrosive pigment, generally known anticorrosive pigments such as chrome anticorrosive pigments such as strontium chromate and strontium calcium; phosphate anticorrosive pigments such as zinc phosphate, aluminum phosphate, zinc phosphate and aluminum phosphate; and silica pigments such as fumed silica and colloidal silica, can be used.

As the binder for the coating of the present invention, generally known resins for coatings such as polyester resins, epoxy resins, urethane resins, acrylic resins and fluorine resins can be used as a main resin. Furthermore, as the crosslinking agent, generally known crosslinking agents such as melamine resins and isocyanates can be used. The coating resin used for the under layer coating and upper layer coating in the present invention is preferably of a type of a polyester resin crosslinked with a melamine resin or an isocyanate since it has an excellent workability.

The polyester is more preferably a polymer type one having a number average molecular weight of 10000 to 26000 since it has a more excellent workability. Conventionally, it has been known that a coating using a polyester having a higher molecular weight has an inferior image clarity to that of a coating using a polyester having a lower molecular weight. Specifically, it was known that a coating using a polymer type polyester having a number average molecular weight of 10000 to 26000 has an inferior image clarity to the case where a polyester having a low molecular type (number average molecular weight is lower than 10000) polyester is used, and thus a low molecular type polyester resin having an inferior workability must be used in order to obtain high image clarity. However, it is more preferable to apply the technique of the present invention since a high image clarity can be obtained even a polymer type polyester having an excellent workability is used. As the polyester resin used for the present invention, commercially available ones may be used.

The melamine resin and isocyanate used as a crosslinking agent may be generally known ones, and commercially available ones, for example, CYMEL (registered trademark) series and MICOAT (registered trademark) series, which are melamine resins manufactured by Mitsui Cytec Ltd., SUPER BECKAMINE (registered trademark) series, which are melamine resins manufactured by DIC Corporation; SUMIJUL (registered trademark) series and DESMODULE (registered trademark) series, which are isocyanates manufactured by Sumika Bayer Urethane Co., Ltd., and the like can be used.

A generally known curing catalyst for accelerating crosslinking of the coating may be added to the coating of the present invention. In addition, other generally known additives for coating such as waxes, leveling agents, defoaming agents and ultraviolet absorbing agents may be added.

It is more preferable that the glass transition temperature of the under layer coating and upper layer coating in the present invention is 10 to 30° C. since the workability is further improved. It may be unpreferable that the glass transition temperature of the coating is lower than 10° C. since the hardness of the coating decreases, and that the temperature exceeds 30° C. since workability may decrease.

It is preferable that the coating thickness of the precoated metal sheet of the present invention is 10 to 25 μm for the under layer coating and 5 to 25 μm for the upper layer coating. When the coating thickness of the under layer coating is lower than 10 μm, the whiteness degree may be low and the L-value in terms of Hunter Lab color system may be lower than 80, and when the coating thickness exceeds 25 μm, application defect referred to as boiling may occur upon application and baking of the coating. When the coating thickness of the upper layer coating is lower than 5 μm, a high image clarity may not be obtained, or when the coating thickness exceeds 25 or more, an application defect referred to as boiling may occur.

In the precoated metal sheet of the present invention, where necessary, an anticorrosive coating or the like may be applied as a primer coating on the further inferior layer of the under layer coating. However, if an anticorrosive coating is provided to the precoated metal sheet of the present invention, it is difficult to be produced by a generally-prevailing precoated steel sheet continuous coating line (generally referred to as CCL (Coil Coating Line) or color steel sheet line) for two-coat application and needs to be produced by newly providing a coating apparatus and a baking furnace or by running the sheet two times through the continuous coating line for two-coat application, and thus problems that facility investments are necessary, the production efficiency is low, the production costs are high, and the like occur. Therefore, it is more preferable that the precoated metal sheet of the present invention includes two coats consisting of the under layer coating and the upper layer coating since existing facilities can be utilized without change.

In the precoated metal sheet of the present invention, where necessary, a clear coating may be applied to a further superior layer on the upper layer coating in the present invention. It is more preferable to apply a top clear coating since image clarity and gloss are further increased. For the top clear coating, a generally known clear coating being free from pigments and dyes can be used, and those exemplified as the resins and crosslinking agents used for the upper layer coating and under layer coating of the present invention can be used. The coating thickness of the top clear coating can be determined by appropriate selection as necessary, and is preferably 1 to 20 μm. When the coating thickness is lower than 1 μm, an effect of providing the top clear coating may not be exhibited, and when the coating thickness exceeds 20 μm, boiling defect may appear during baking.

The coating to be applied to the precoated metal sheet of the present invention can be applied by a generally-known coating method such as a roll coater, a roller curtain coater, a wringer roll coater and spray coating, and thereafter baked in a generally known baking furnace for coatings such as a hot air drying furnace, an induction heating furnace and an infrared ray heating furnace, or a furnace using these furnaces in combination.

For the metal sheet used for the present invention, generally known metal materials can be used. The metal material may be an alloy material. Examples may include steel sheets, stainless steel sheets, aluminum sheets, aluminum alloy sheets, titanium sheets, copper sheet and the like. The surfaces of these materials may be plated. Examples of the kinds of plating may include zinc plating, aluminum plating, copper plating, nickel plating and the like. Alloy plating of these may also be used. If a steel sheet is used, generally known steel sheets and plated steel sheets such as molten zinc-plated steel sheets, electrically zinc-plated steel sheets, zinc-nickel alloy-plated steel sheets, molten alloyed zinc-plated steel sheets, aluminum-plated steel sheets and aluminum-zinc alloyed plated steel sheets can be applied.

It is more preferable to provide a generally known chemical conversion coating to the surface of the metal sheet used in the present invention since the adhesion between the metal sheet and the coating layer is improved. As the chemical conversion coating, phosphate-zinc chemical conversion coating, coating chromate treatment, electrolysis chromic acid treatment, reaction chromate treatment, chromate-free chemical conversion coating and the like can be used.

### EXAMPLES

### Example-1

Hereinafter, the details of Example-1 are described.

First, the details of the coatings used in Example-1 are described.

Solutions of “VYLON (registered trademark) GK140” (Tg: 20° C., number average molecular weight: 13000), “VYLON (registered trademark) 650” (Tg: 10° C., number average molecular weight: 23000), “VYLON (registered trademark) 600” (Tg: 47° C., number average molecular weight: 23000), “VYLON (registered trademark) GK180” (Tg: 0° C., number average molecular weight: 10000), “VYLON (registered trademark) GK130” (Tg: 15° C., number average molecular weight: 7000) and “VYLON (registered trademark) 220” (Tg: 53° C., number average molecular weight: 3000), which are amorphous polyester resins manufactured by Toyobo Co., Ltd., in an organic solvent (a mixture of cyclohexanone: SOLVESSO 150=1:1 by mass ratio) were prepared. Furthermore, “LUMIFLON (registered trademark) LF552” (Tg: 20° C., number average molecular weight 12000), which is a fluorine-based resin manufactured by Asahi Glass Co., Ltd., was also prepared. Then, “CYMEL (registered trademark) 303”, which is a melamine resin manufactured by Mitsui Cytec Ltd. and “CATALYST 600”, which is a strongly acidic catalyst manufactured by Mitsui Cytec Ltd. were added to the above-mentioned resins to prepare melamine-curing type polyester clear coatings. The amount of the crosslinking agent added was 30 parts by mass of the melamine resin with respect to 70 parts by mass of the polyester resin by solid content ratio. The amount of the catalyst added was 0.5 mass % with respect to the total resin solid content of the polyester resin and the melamine resin. Furthermore, “SUMIJUL (registered trademark) BL3175” manufactured by Sumika Bayer Urethane Co., Ltd., which is a blocked isocyanate including a commercial HDI as a base, was incorporated into the polyester resins dissolved in the organic solvent so that [equivalent amount of NCO groups in isocyanate]/[equivalent amount of OH groups in polyester resin] became 1.0, and “TK-1”, which is a reaction catalyst manufactured by Mitsui Takeda Chemical Inc., was added by 0.05% with respect to the resin solid content to give isocyanate-curing type polyester-based clear coatings.

Next, where necessary, “TIPAQUE (registered trademark) CR-95”, which is titanium oxide manufactured by Ishihara Sangyo Kaisha Ltd., was added to the prepared clear coating.

Hereinafter, the details of the precoated metal sheets used for Example-1 are described.

As base sheets, “SILVERZINC (registered trademark)” (hereinafter referred to as GI), which is a molten zinc-plated steel sheet manufactured by Nippon Steel Corporation, “ZINCLITE (registered trademark)” (hereinafter referred to as ZL), which is a zinc-nickel alloy-plated steel sheet manufactured by Nippon Steel Corporation, and “ZINCOAT (registered trademark)” (hereinafter referred to as EG), which is an electrically zinc-plated steel sheet manufactured by Nippon Steel Corporation, were prepared. Those having a sheet thickness of 0.6 mm were used. The amount of the adhered plating of ZL used in this experiment was 20 g/m² on one surface, and the amount of nickel in the plated layer was 12%. Furthermore, GI having an amount of the adhered plating of 60 mg/m² on one surface and EG having an amount of the adhered plating of 20 g/m² on one surface were used.

Next, the prepared base sheets were spray-degreased by using “FC-4336”, which is an alkaline degreasing liquid manufactured by Nihon Parkerizing Co., Ltd. (2 mass % concentration, 50° C. aqueous solution), washed with water and dried, and thereafter “ZM-1300AN”, which is a chromate treatment manufactured by Nihon Parkerizing Co., Ltd., was applied using a roll coater and dried in a hot air oven. The drying condition in the hot air oven was adjusted to 60° C. by the achieved sheet temperature of the steel sheet. The application was conducted so that the amount of the adhered chromate treatment became 50 g/m² in terms of the amount of adhered Cr.

Next, the prepared coating as an under layer coating was applied to one surface of the metal sheet that had been subjected to a chemical conversion coating, and “FL100HQ” (gray, a coating manufactured by Nippon Fine Coatings, Inc.) was applied to another surface as a back surface coating, respectively, by a roll coater, and cured by drying in an induction heating furnace while blowing hot air under the condition that the achieved sheet temperature of the metal sheet became 210° C. After dry baking, water cooling was conducted by spraying water on the coated metal sheet using a spray.

Next, the prepared coating was applied to the under layer coating as an upper layer coating using a roll coater, respectively, and cured by drying in an induction heating furnace while blowing hot air under the condition that the achieved sheet temperature of the metal sheet became 210° C. Then, after dry baking, water cooling was conducted by spraying water on the coated metal sheet using a spray.

These series of coating operations were conducted in a continuous coating line for two-coat. Furthermore, where necessary, a precoated metal sheet having three-layer coating in which a primer coating had been applied under the under layer coating was prepared. During preparation of the precoated metal sheet of three-layer coating, a chromate treatment was applied to the metal sheet in a continuous coating line for two-coat to prepare a precoated metal sheet on which a primer coating and an under layer coating had been applied, and thereafter an upper layer coating was applied again in the continuous coating line for two-coat. During second passing through the continuous coating line, only the upper layer coating was applied without degreasing and chromate treatment. The coating condition during application of the primer coating was similar to the condition during application of the under layer coating.

In the prepared precoated metal sheet, the coating thickness was adjusted to 20 μm for the under layer coating and to 10 μm for the upper layer coating. The primer coating was adjusted to 5 μm. The coating thickness of the coating was controlled by adjusting the revolution rate of the rolls, the clamping pressure between the rolls and the coating viscosity in the case of a roll coater. Each coating thickness was measured using “LE-200J”, which is an electromagnetic coating thickness meter manufactured by KET.

Hereinafter, the details of the evaluation method for the precoated metal sheet prepared in Example-1 is described.

### 1. Measurement of Glass Transition Temperature (Tg) of Coating

The Tg of the coating was measured using “SSC5200 Series TMA/SS120C”, which is a thermomechanical analyzer manufactured by Seiko Electronic Inc. As the probe during the measurement, a needle probe was used.

### 2. Measurement of Image Clarity

The Gd value was measured using a portable image clarity and gloss meter “PGD” (manufactured by Tokyo Koden Co., Ltd.). Furthermore, when the measured Gd value was 0.3 or more, it was evaluated as O, when the value was 0.1 or more and lower than 0.3, it was evaluated as Δ, and when the value was lower than 0.1, it was evaluated as ×.

### 3. Measurement of Color Tone

Color was measured according to JIS. K. 5400. 7. 4. 2. Since all precoated metal sheet samples were colored white in this experiment, focusing on L-value, which is an index of whiteness degree, the sample having an L-value of 90 or more was evaluated as O, the sample having an L-value of 80 or more and lower than 90 was evaluated as Δ, and the sample having an L-value of lower than 80 was evaluated as ×.

4. Workability Test of Coating

The prepared precoated metal sheet was subjected to 180° bending processing (adhesion bending processing), and the coating in the processed portion was visually observed to check the presence or absence of cracks on the coating. During the 180° bending, adhesion bending was conducted after bending the precoated metal sheet so that its surface becomes outer side of the bending (generally known as OT bending). The processed portion was observed by a magnifying glass (×10), and the case where coating cracks and peeling were not observed at all was evaluated as O, the case where slight cracks and peeling were observed on the coating was evaluated as Δ, and the case where the coating has large cracks and peeling was evaluated as ×.

5. Pencil Hardness Test of Coating

Pencil hardness test was conducted according to JIS. K. 5600. 5. 4 and the pencil hardness value was obtained when the impression by a pencil (plasticity deformation defect) was evaluated, and the case where the pencil hardness was F or more was evaluated as O, the case where the hardness was B or HB was evaluated as Δ, and the case where the hardness was 2B or less was evaluated as ×.

Hereinafter, the details of the evaluation results of Example-1 are described.

TABLE 1

| | | | UNDER | | | | | | | |
|---|---|---|---|---|---|---|---|---|---|---|
| | | | LAYER COATING | | | | | | | |
| | | | | | | | AMOUNT OF | UPPER | | |
| | | | | | | | TITANIUM | LAYER COATING | | |
| | BASE | | RESIN | | | CROSSLINKING | OXIDE ADDED | RESIN | | |
| No. | SHEET | PRIMER | TYPE* | Tg (° C.) | Mn | AGENT | (MASS %) | TYPE* | Tg (° C.) | Mn |
| 1 | ZL | OFF | B-GK140 | 20 | 13000 | MELAMINE | 40 | B-GK140 | 20 | 13000 |
| 2 | ZL | OFF | B-GK140 | 20 | 13000 | MELAMINE | 50 | B-GK140 | 20 | 13000 |
| 3 | ZL | OFF | B-GK140 | 20 | 13000 | MELAMINE | 60 | B-GK140 | 20 | 13000 |
| 4 | ZL | OFF | B-GK140 | 20 | 13000 | MELAMINE | 50 | B-GK140 | 20 | 13000 |
| 5 | ZL | OFF | B-GK140 | 20 | 13000 | MELAMINE | 50 | B-GK140 | 20 | 13000 |
| 6 | ZL | OFF | B-GK140 | 20 | 13000 | ISOCYANATE | 50 | B-GK140 | 20 | 13000 |
| 7 | ZL | OFF | B-650 | 10 | 23000 | MELAMINE | 50 | B-650 | 10 | 23000 |
| 8 | ZL | OFF | B-600 | 47 | 23000 | MELAMINE | 50 | B-600 | 47 | 23000 |
| 9 | ZL | OFF | B-GK180 | 0 | 10000 | MELAMINE | 50 | B-GK180 | 0 | 10000 |
| 10 | ZL | OFF | B-GK130 | 15 | 7000 | MELAMINE | 50 | B-GK130 | 15 | 7000 |
| 11 | ZL | OFF | B-220 | 53 | 3000 | MELAMINE | 50 | B-220 | 53 | 3000 |
| 12 | GI | OFF | B-GK140 | 20 | 13000 | MELAMINE | 50 | B-GK140 | 20 | 13000 |
| 13 | EG | OFF | B-GK140 | 20 | 13000 | MELAMINE | 50 | B-GK140 | 20 | 13000 |
| 14 | EG | ON | B-GK140 | 20 | 13000 | MELAMINE | 50 | B-GK140 | 20 | 13000 |
| 15 | EG | OFF | B-GK140 | 20 | 13000 | MELAMINE | 50 | LF-552 | 20 | 13000 |
| 16 | ZL | OFF | B-GK140 | 20 | 13000 | MELAMINE | 30 | B-GK140 | 20 | 13000 |
| 17 | ZL | OFF | B-GK140 | 20 | 13000 | MELAMINE | 70 | B-GK140 | 20 | 13000 |
| 18 | ZL | OFF | B-GK140 | 20 | 13000 | MELAMINE | 50 | B-GK140 | 20 | 13000 |
| 19 | ZL | OFF | B-GK140 | 20 | 13000 | MELAMINE | 50 | B-GK140 | 20 | 13000 |
| 20 | ZL | OFF | B-650 | 10 | 23000 | MELAMINE | 50 | B-650 | 10 | 23000 |

| | UPPER | | | | | | | |
|---|---|---|---|---|---|---|---|---|
| | LAYER COATING | | | | | | | |
| | | AMOUNT OF | | | | | | |
| | | TITANIUM | | | | | | |
| | CROSSLINKING | OXIDE ADDED | COATING | IMAGE | COLOR | | PENCIL | |
| No. | AGENT | (MASS %) | Tg (° C.) | CLARITY | TONE | WORKABILITY | HARDNESS | NOTES |
| 1 | MELAMINE | 15 | 23 | ◯ | Δ | ◯ | ◯ | INVENTION |
| 2 | MELAMINE | 15 | 23 | ◯ | ◯ | ◯ | ◯ | EXAMPLES |
| 3 | MELAMINE | 15 | 23 | ◯ | ◯ | ◯ | ◯ | |
| 4 | MELAMINE | 5 | 23 | ◯ | Δ | ◯ | Δ | |
| 5 | MELAMINE | 25 | 23 | ◯ | ◯ | ◯ | ◯ | |
| 6 | ISOCYANATE | 15 | 23 | ◯ | ◯ | ◯ | ◯ | |
| 7 | MELAMINE | 15 | 13 | ◯ | ◯ | ◯ | ◯ | |
| 8 | MELAMINE | 15 | 49 | ◯ | ◯ | Δ | ◯ | |
| 9 | MELAMINE | 15 | 5 | ◯ | ◯ | ◯ | Δ | |
| 10 | MELAMINE | 15 | 19 | ◯ | ◯ | Δ | ◯ | |
| 11 | MELAMINE | 15 | 56 | ◯ | ◯ | Δ | ◯ | |
| 12 | MELAMINE | 15 | 23 | ◯ | ◯ | ◯ | ◯ | |
| 13 | MELAMINE | 15 | 23 | ◯ | ◯ | ◯ | ◯ | |
| 14 | MELAMINE | 15 | 23 | ◯ | ◯ | ◯ | ◯ | |
| 15 | MELAMINE | 15 | 23 | ◯ | ◯ | ◯ | Δ | |
| 16 | MELAMINE | 15 | 23 | ◯ | X | ◯ | ◯ | COMPARATIVE |
| 17 | MELAMINE | 15 | 23 | ◯ | ◯ | X | ◯ | EXAMPLES |
| 18 | MELAMINE | 0 | 23 | ◯ | X | ◯ | X | |
| 19 | MELAMINE | 50 | 23 | X | ◯ | ◯ | ◯ | |
| 20 | MELAMINE | 50 | 13 | X | ◯ | ◯ | ◯ | |

*IN THE TYPE OF RESIN, “B-” IS A SYMBOL REPRESENTING “VYLON (REGISTERED TRADEMARK)”, WHICH IS A POLYESTER RESIN MANUFACTURED BY TOYOBO CO., LTD.
THE “LF” IS A SYMBOL REPRESENTING “LUMIFLON (REGISTERED TRADEMARK)”, WHICH IS A FLUORINE-BASED RESIN MANUFACTURED BY ASAHI GLASS CORPORATION.

The details and the evaluation results of the precoated metal sheets prepared in the present invention are shown in Table 1.

The precoated metal sheets of the present invention (Invention Examples 1 to 15) have an excellent color tone, and have a high image clarity. The sheet having a white pigment concentration of the under layer coating of less than 40 mass % (Comparative Example 16) cannot obtain a high whiteness degree, and the sheet having the concentration of more than 60% (Comparative Example 17) is poor in workability. The sheet having a white pigment concentration of the upper layer coating of less than 5% (Comparative Example 18) cannot obtain a high whiteness degree, and the sheets having the concentration of more than 25% (Comparative Examples 19 and 20) are poor in image clarity.

Since the sheet having an under layer coating layer under which a primer coating has been applied (Invention Example 14) must be produced by passing the sheet twice through the continuous coating line, the operation is inefficient and the production cost is increased. Therefore, the precoated metal sheet of the present invention is preferably of two-coat.

It is more preferable that the main resin in the coating of the precoated metal sheet of the present invention is a polyester, and the sheet using a resin other than polyester (Invention Example 15) tends to have a poor workability. Furthermore, the glass transition temperature of the coating is preferably 10 to 30° C., and the sheet having a glass transition temperature of lower than 10° C. (Invention Example 9) tends to have a poor pencil hardness, and the sheet having a glass transition temperature of more than 30° C. (Invention Examples 8 and 11) tends to have a poor workability.

### Example-2

Hereinafter, the details of Example-2 are described.

First, the details of the samples prepared in Example-2 are described.

Using the same base sheet, the same under layer coating and the same upper layer coating as those of the precoated metal sheet of Invention Example 2 prepared in Example-1, samples having an under layer coating and an upper layer coating having different thicknesses were prepared. The preparation method of the precoated metal sheet was similar to that of Example-1.

Next, the details of the evaluation method for the precoated metal sheets prepared in Example-2 are described.

Similar evaluations to that of Example-1 were conducted. Furthermore, 6. Observation of appearance as mentioned below was additionally conducted.

### 6. Observation of Appearance

The appearance of the prepared precoated metal sheet was observed visually and using a magnifying glass (×10) to observe the presence or absence of coating defect. The case where no coating defect was recognized either by visual observation or observation using a magnifying glass (×10) was evaluated as O, the case where no coating defect was observed visually but blister-like coating defect was observed by a magnifying glass (×10) was evaluated as Δ, and the case where blister-like coating defect was observed by visual observation was evaluated as ×.

Hereinafter, the details of the evaluation results of Example-2 are described in the following Table 2.

TABLE 2

| | | | UNDER LAYER COATING | | UPPER LAYER COATING | |
|---|---|---|---|---|---|---|
| | | | | COATING | | COATING |
| | BASE | | | THICKNESS | | THICKNESS |
| No. | SHEET | PRIMER | TYPE | (μm) | TYPE | (μm) |
| 21 | ZL | NONE | UNDER LAYER COATING | 10 | UPPER LAYER COATING | 10 |
| 22 | ZL | NONE | SIMILAR TO THAT OF | 15 | SIMILAR TO THAT OF | 10 |
| 23 | ZL | NONE | INVENTION EXAMPLE 2 IN | 25 | INVENTION EXAMPLE 2 IN | 10 |
| 24 | ZL | NONE | [EXAMPLE 1] WAS USED | 30 | [EXAMPLE 1] WAS USED | 10 |
| 25 | ZL | NONE | | 20 | | 3 |
| 26 | ZL | NONE | | 20 | | 5 |
| 27 | ZL | NONE | | 20 | | 25 |
| 28 | ZL | NONE | | 20 | | 30 |

| | COATING | APPEARANCE | IMAGE | COLOR | | PENCIL | |
|---|---|---|---|---|---|---|---|
| No. | Tg (° C.) | OF COATING | CLARITY | TONE | WORKABILITY | HARDNESS | NOTES |
| 21 | 23 | ◯ | ◯ | Δ | ◯ | ◯ | INVENTION |
| 22 | 23 | ◯ | ◯ | ◯ | ◯ | ◯ | EXAMPLES |
| 23 | 23 | ◯ | ◯ | ◯ | ◯ | ◯ | |
| 24 | 23 | Δ | ◯ | ◯ | ◯ | ◯ | |
| 25 | 23 | ◯ | Δ | ◯ | ◯ | ◯ | |
| 26 | 23 | ◯ | ◯ | ◯ | ◯ | ◯ | |
| 27 | 23 | ◯ | ◯ | ◯ | ◯ | ◯ | |
| 28 | 23 | Δ | ◯ | ◯ | ◯ | ◯ | |

As is apparent from the results shown in Table 2, the coating thickness of the under layer coating of the precoated metal sheet of the present invention is preferably 10 to 25 μm. The sheet having that thickness of 10 μm tends to have a slightly decreased whiteness degree (Invention Example 21), and the sheet having that thickness of more than 25 μm (Invention Example 24) tends to generate blister defect. The coating thickness of the upper layer coating is preferably 5 to 25 μm. The sheet having that thickness of lower than 5 μm (Invention Example 25) tends to have a slightly decreased whiteness degree, and the sheet having that thickness of more than 25 μm (Invention Example 28) tends to generate blister defect.

### Example-3

Hereinafter, the details of Example-3 are described.

First, the details of the samples prepared in Example-3 are described.

A clear coating was applied to each of the precoated metal sheets of Invention Examples 21 to 28 prepared in Example-2 using a roll coater, and baked under the condition of the achieved sheet temperature of 230° C. to prepare precoated metal sheets. As the clear coating, “VYLON (registered trademark) GK140”, which is a polyester resin manufactured by Toyobo Co., Ltd., to which “CYMEL (registered trademark) 303”, which is a melamine resin manufactured by Mitsui Cytec Ltd., and “CATALYST 600”, which is a catalyst manufactured by Mitsui Cytec Ltd., had been added, was used. The amount of the crosslinking agent added was 30 parts by mass of the melamine resin with respect to 70 parts by mass of the polyester resin by solid content ratio, and the amount of the catalyst added was 0.5 mass % with respect to the total resin solid content of the polyester resin and the melamine resin.

Next, the details of the evaluation method for the precoated metal sheet prepared in Example-3 are described.

Evaluations similar to Example-2 were conducted.

TABLE 3

| | BASE METAL SHEET | | | | | | |
|---|---|---|---|---|---|---|---|
| | TO WHICH CLEAR COATING | APPEARANCE | IMAGE | COLOR | | PENCIL | |
| No. | IS TO BE APPLIED | OF COATING | CLARITY | TONE | WORKABILITY | HARDNESS | NOTES |
| 29 | PCM OF INVENTlON EXAMPLE 21 | ◯ | ◯ | Δ | ◯ | ◯ | INVENTION |
| 30 | PCM OF INVENTION EXAMPLE 22 | ◯ | ◯ | ◯ | ◯ | ◯ | EXAMPLES |
| 31 | PCM OF INVENTION EXAMPLE 23 | ◯ | ◯ | ◯ | ◯ | ◯ | |
| 32 | PCM OF INVENTION EXAMPLE 24 | Δ | ◯ | ◯ | ◯ | ◯ | |
| 33 | PCM OF INVENTION EXAMPLE 25 | ◯ | ◯ | ◯ | ◯ | ◯ | |
| 34 | PCM OF INVENTION EXAMPLE 26 | ◯ | ◯ | ◯ | ◯ | ◯ | |
| 35 | PCM OF INVENTION EXAMPLE 27 | ◯ | ◯ | ◯ | ◯ | ◯ | |
| 36 | PCM OF INVENTION EXAMPLE 28 | Δ | ◯ | ◯ | ◯ | ◯ | |

The precoated metal sheets of the present invention in which the clear coating has been further applied to the upper layer coating (Invention Examples 29 to 36) are more preferable since image clarity is improved.

Although the preferred embodiments of the present invention are described above, it is needless to say that the present invention is not limited to such examples. It is apparent that the skilled persons in the art can conceive various modified examples or altered examples within the scope described in the claims, and such examples are also naturally considered to belong to the technical scope of the present invention.

1. A white precoated metal sheet having a post-coating whiteness degree of 80 or more in terms of L-value of Hunter Lab color system, comprising a metal sheet and two or more coating layers applied thereon, characterized in that, when an upper layer coating refers to the coating of an outermost surface layer and an under layer coating refers to the coating layer adjacent to the bottom of the upper layer coating, the concentration of a white pigment in the under layer coating is 40 to 60 mass % and the concentration of a white pigment in the upper layer coating is 5 to 25 mass %.

2. The precoated metal sheet according to claim 1, characterized in that the white pigment is titanium oxide.

3. The precoated metal sheet according to claim 1 or 2, characterized in that a resin that forms the under layer coating and the upper layer coating is a resin comprising a polyester resin as a main resin which has been crosslinked by a melamine resin or an isocyanate.

4. The precoated metal sheet according to any one of claims 1 to 3, characterized in that the glass transition temperature of the under layer coating and the upper layer coating is 10 to 30° C.

5. The precoated metal sheet according to any one of claims 1 to 3, characterized in that the coating thickness of the under layer coating is 10 to 25 μm, and the coating thickness of the upper layer coating is 5 to 25 μm.

6. The precoated metal sheet according to any one of claims 1 to 5, characterized in that the coating of the precoated metal sheet comprises two layers.

7. The precoated metal sheet according to any one of claims 1 to 5, characterized in that a clear coating has been further applied on the upper layer coating of the precoated metal sheet.
